(19) United States
(12) Patent Application Publication
(10) Pub. No.: US 2008/0266490 A1
(43) Pub. Date: Oct. 30, 2008

(54) LIGHTING APPARATUS AND LIQUID CRYSTAL DISPLAY APPARATUS

(75) Inventors: Masahiko Mizuki, Kanagawa (JP); Eri Fukumoto, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/108,939

(22) Filed: Apr. 24, 2008

(30) Foreign Application Priority Data
Apr. 24, 2007 (JP) 2007-117846

(51) Int. Cl. F21V 1/00; H01J 1/62; G02F 1/1335

(52) U.S. Cl. 349/69; 362/235; 313/504

(57) ABSTRACT

A lighting apparatus with a plurality of light emitting panels (for example, organic EL panels) arranged in a plane to form a light emitting panel layer (organic EL panel arrangement) and a plurality of such light emitting panel layers (light emitting panel layers) are laminated to form a light emitting panel lamination section. Organic EL panels of the single-sided light emitting type and organic EL panels of the double-sided light emitting type can be individually juxtaposed in a plane to form the organic EL panel arrangements which are laminated in a displaced relationship from each other.

### CROSS REFERENCE TO RELATED APPLICATIONS

This application claims priority to Japanese Patent Application No. 2007-117846, filed in the Japanese Patent Office on Apr. 27, 2007. Japanese Patent Application No. 2007-117846 is incorporated herein by reference in its entirety for all purposes to the extent permitted by law.

### BACKGROUND OF THE INVENTION

This invention relates to a lighting apparatus and a liquid crystal display apparatus wherein a plurality of light emitting panels are used.

A liquid crystal display apparatus requires light from the outside because it is not self-luminous. A backlight is incorporated for the light from the outside. Such backlights are roughly divided in terms of the structure principally into a direct type backlight, an edge light type backlight and a planar light source type backlight.

The direct type backlight includes cold cathode tubes and a reflecting film placed just behind an LCD (Liquid Crystal Display) panel and serving as a planar light source. However, in order to make dark and bright places at arrangement distances of the cold cathode tubes less conspicuous to obtain a uniform planar light source, a sufficient depthwise dimension of 20 mm to 40 mm is required. This is the most significant factor of increasing the thickness of the liquid crystal display apparatus.

Meanwhile, the edge light type backlight includes cold cathode tubes placed on a side face of a light guide plate and serving as a planar light source. Although the edge light type backlight is slim, it is comparatively low in luminance and is very heavy due to use of the light guide plate. Accordingly, the planar light source type backlight is ideal for television applications.

In the planar light source type backlight, an organic electroluminescence device panel (hereinafter referred to as organic EL panel) and a planar type fluorescent lamp are used. Since particularly the organic EL panel includes a comparatively small number of members and does not require an inverter, it can be formed as of a slim type in principle and can become a backlight suitable for a slim television set.

The organic EL panel is characterized in low voltage driving, good color reproducibility, a high response speed, slim formation and so forth. However, it is not realistic to increase the size of the organic EL backlight with a single panel in conformity with an increase of the screen size while uniform light emitting quality free from irregularity in luminance is achieved because it is influenced much by the required scale for a vapor deposition apparatus in the aspect of fabrication and the voltage drop caused by increase of the size in the aspect of physical properties.

In order to solve this, for example, Patent Document 1, Japanese Patent Laid-Open No. 2005-183352 discloses a technique of joining a plurality of small-size organic EL panels in a juxtaposed relationship with each other in order to cope with an increase of the size. Further, according to the technique disclosed in Patent Document 1 mentioned above, special light diffusion means is provided at a joint portion of each adjacent light emitting panels.

However, a light emitting apparatus of a large size wherein a plurality of small-sized light emitting panels are juxtaposed has problems that it is necessary to provide special light diffusion means at a joint of each adjacent light emitting panels and that improvement in luminance and uniformization over the overall light emitting apparatus cannot be achieved sufficiently.

### SUMMARY OF THE INVENTION

The present invention provides solutions to the just described problems.

In that regard, in an embodiment, the present invention provides a lighting apparatus which includes a light emitting panel layer formed from a plurality of light emitting panels disposed in a plane, and a light emitting panel lamination section formed from a plurality of such light emitting panel layers laminated on each other.

In particular, a plurality of double-sided and single-sided small-sized organic EL apparatus are arranged in a superposed relationship in layers to form a lighting apparatus, which is used, for example, as a backlight of a liquid crystal display apparatus. In the embodiment having such a configuration as just described, implementation of a high luminance over the overall lighting apparatus and enhancement in-plane uniformization can be achieved.

In the lighting apparatus of the present embodiment, for example, a light emitting panel layer which has a reflecting layer which reflects light is provided on the upper side is applied as the light emitting panel layer which is arranged most downwardly from among the plurality of light emitting panel layers which form the light emitting panel lamination section. Here, in the present embodiment, the direction in which the light emitting panel layers are laminated, that is, a taking out direction of light, is defined as an upward and downward direction, and the light taking out face side is defined as an upper side while the opposite side is a lower side.

Further, in a lighting apparatus embodying principles of the present embodiment, the plurality of light emitting panels are arranged such that the positions thereof are displaced from each other upwardly and downwardly of the plurality of light emitting panel layers which form the light emitting panel lamination section; the plurality of light emitting panels are arranged such that the positions of boundary lines thereof are displaced from each other upwardly and downwardly of the plurality of light emitting panel layers which form the light emitting panel lamination section; light emitting panels having different sizes are used as the plurality of light emitting panels upwardly and downwardly of the plurality of light emitting panel layers which form the light emitting panel lamination section; or the plurality of light emitting panels are arranged such that they are different in arrangement angle upwardly and downwardly of the plurality of light emitting panel layers which form the light emitting panel lamination section.

By this, light emission at joint portions of a plurality of light emitting panels which form each light emitting panel layer is interpolated with each other between the upper and lower light emitting panels upwardly and downwardly of the plurality of light emitting panel layers. Consequently, the uniformity over the overall lighting apparatus can be enhanced.

Since a plurality of light emitting panels are disposed in a juxtaposed relationship as a light emitting panel layer, interlayer column-sequential lighting wherein lighting of the light emitting panels in the columns is carried out in order of the layers in the plurality of light emitting panel layers which form the light emitting panel lamination section can be implemented.

As the light emitting panels, the present embodiment uses a light emitting panel which includes an organic EL light emitting layer.

Further, in the present embodiment, the lighting apparatus described above is applied as lighting means for a liquid crystal display apparatus.

According to principles of the invention, the following effects are achieved. In particular, it becomes possible to achieve a high luminance and high uniformization of a lighting apparatus while the lighting apparatus has a large size. Further, where the lighting apparatus is applied, it is possible to obtain an image of high quality which has a high luminance and has high uniformity.

### BRIEF DESCRIPTION OF THE DRAWINGS

FIG. 1 is a schematic sectional view illustrating a general configuration of a single-sided light emitting type organic EL panel.

FIG. 2 is a schematic sectional view illustrating a general configuration of a double-sided light emitting type organic EL panel.

FIG. 3 is a schematic view illustrating an example of arrangement of a small-sized organic EL panel.

FIG. 4 is a schematic view illustrating scanning driving.

FIG. 5 is a schematic sectional view showing an example wherein a lighting apparatus of the present embodiment is applied to a liquid crystal display apparatus.

FIG. 6 is schematic views illustrating examples wherein arrangements of organic EL panels in upward and downward organic EL panel arrangements are displaced in one direction.

FIG. 7 is a schematic view showing an example wherein organic EL panels in upward and downward EL panel arrangements are difference in size.

FIG. 8 is schematic views showing examples wherein organic EL panels in upward and downward organic EL panel arrangements are different in angle.

### DETAILED DESCRIPTION OF THE PRESENTLY PREFERRED EMBODIMENTS

In the following, an embodiment of the present invention is described with reference to the figures. The lighting apparatus according to the present embodiment is applied principally as a backlight for a liquid crystal display apparatus and is configured such that a plurality of light emitting panels are disposed in a plane to form a light emitting panel layer and a plurality of such light emitting panel layers are laminated to form a light emitting panel lamination section. Here, for the light emitting panel, for example, an organic EL (Electro Luminescence) panel is used.

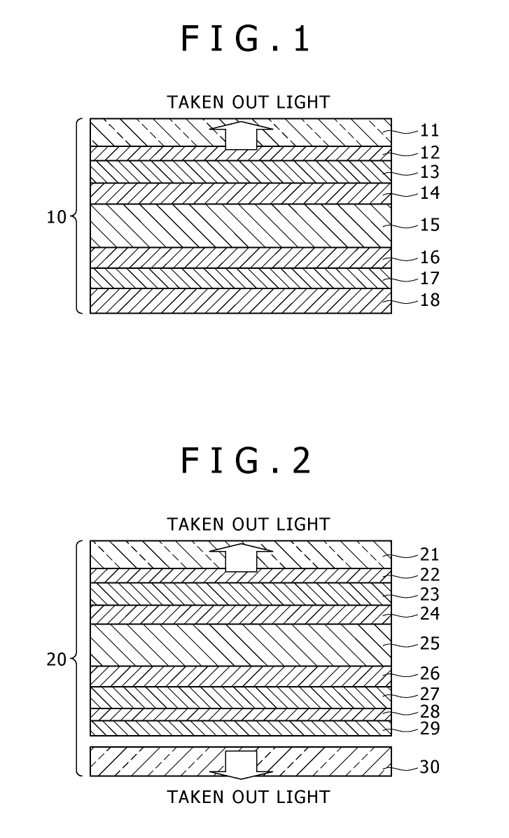

First, a white organic EL device used as a backlight is described. A general configuration of a single-sided light emitting type organic EL panel as an example of this organic EL device is shown in FIG. 1. The single-sided light emitting type organic EL panel 10 includes two electrodes opposing to each other, and an organic EL layer disposed between the two electrodes and can be driven with a comparatively low voltage of approximately 5 to 20 V.

A light emitting section has a layer configuration of an ITO anode layer 12, a hole injection layer 13, a hole transport layer 14, an organic light emitting layer 15, an electron transport layer 16, an electron injection layer 17 and a metal cathode electrode 18 in order from a glass substrate 11 side from which generated light is taken out, and is covered with a gas barrier layer not shown.

In the single-sided light emitting type organic EL panel 10, a material having a high work function such as gold or ITO (indium-tin oxide) is used as a hole injection electrode while an electron injection electrode is formed from a lamination film of a high reflectance metal such as aluminum (Al) or silver (Ag) and a metal material having a low work function such as lithium fluoride and aluminum (LiF/Al) or calcium and magnesium (Ca/Mg). Usually, in order to take out EL light, it is necessary to make at least one of the electrodes transparent, and the ITO which is transparent and has a high work function is used for the hole injection electrode.

In the organic EL panel, if a voltage is applied, then electrons and holes are injected from the electron injection electrode and the hole injection electrode, respectively, into the light emitting section. The electrons and the holes injected are re-coupled at the light emission center to place organic molecules into an excited state. Then, the principle of operation is that, when the organic molecules enter a ground state from the excited state, fluorescent light is emitted. The organic EL material of the light emitting layer is not limited particularly if it is an organic compound which can be used as a light emitting material.

Now, a general configuration of a double-sided light emitting type organic EL panel is shown in FIG. 2. In particular, the double-sided light emitting type organic EL panel 20 includes two electrodes opposing to each other and an organic EL layer disposed between the two electrodes, and can be driven with a comparatively low voltage of approximately 5 to 20 V.

A light emitting section has a layer configuration including an ITO anode layer 22, a hole injection layer 23, a hole transport layer 24, an organic light emitting layer 25, an electron transport layer 26, an electron injection layer 27, a metal cathode electrode 28, an ITO auxiliary electrode 29 and a glass substrate 30 in order from a glass substrate 21 side from which generated light is taken out, and is covered with a gas cover layer not shown.

In the case of the double-sided light emitting type organic EL panel 20, for example, both of the positive electrode and the negative electrode are formed as ITO transparent electrodes and a metal electrode 28 having a film thickness of 0.1 to 30 nm and formed, for example, from a calcium (Ca) layer is deposited or the like between the electron injection layer 27 and the ITO cathode electrode 29 to establish a structure which passes visible rays therethrough.

The two different organic EL panels described above are used such that, in the present embodiment, for example, the single-sided light emitting type organic EL panel 10 wherein a metal material having a high reflectance of visible rays is used for the cathode electrode is arranged in the first layer and the double-sided light emitting type organic EL panel 20 which passes light therethrough is placed as the organic EL panel of the second layer which becomes the light emitting side (liquid crystal panel side), whereby light directed to the since-sided light emitting type organic EL panel of the rear face is reflected by the reflecting layer (metal electrode 18) of the single-sided light emitting type organic EL panel so that the light can be taken out efficiently to the liquid crystal panel side. Since emitted light of the two panels can be utilized efficiently, the accuracy of the entire organic EL backlight can be improved.

Here, if it is tried to increase the organic EL panel as a single item as described above, then there are such possibilities (1) increase in size of a vapor deposition apparatus used in an organic EL panel fabrication process, (2) that the influence of a voltage drop of the organic EL panel becomes significant, (3) that, since the film formation area of the organic EL panel becomes large, film break by stress is likely to occur, and so forth. Therefore, it is not practical to increase the size of an organic EL panel as a single item with uniform light emission quality free from unevenness of the luminance.

In order to solve this, a technique of joining a plurality of small-sized organic EL panels together arranged in a plane to an organic EL panel arrangement (light emitting panel layer) is effective. However, joint portions of adjacent small-sized organic EL panels do not emit light, and as a result, special light diffusion means is required (refer to Patent Document 1).

Therefore, in the present embodiment, a plurality of small-sized organic EL panels are arranged in a plane to form an organic EL panel arrangement (light emitting panel layer), and a plurality of such organic EL panel arrangements are laminated to form a light emitting panel lamination section. Further, such arrangement that the positions of boundary lines (joints) of the plurality of organic EL panels are displaced from each other upwardly and downwardly of the plurality of organic EL panel arrangements which form the light emitting panel lamination section is formed. Consequently, light emission at the joint portions between the organic EL panels is interpolated by the upper and lower organic EL panels, and even if no special light diffusion means is provided at each joint portion, the uniformity over the overall lighting apparatus can be improved.

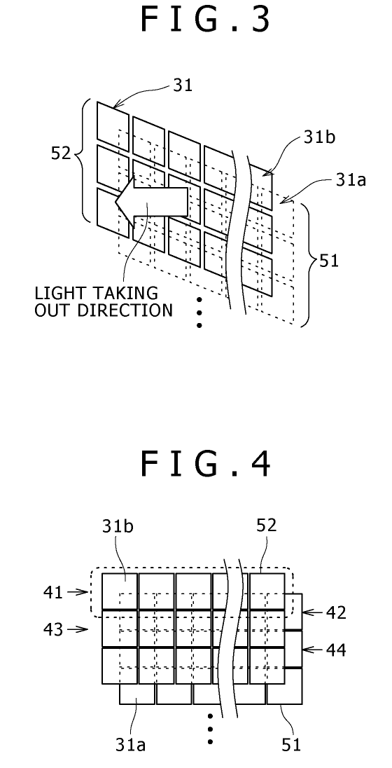

FIG. 3 is a schematic view illustrating an example of arrangement of small-size organic EL panels. It is to be noted that, in the following description, the direction in which organic EL panels are laminated, that is, a taking out direction of light, is an upward and downward direction, and the light taking out face side is defined as an upper side while the opposite side is a lower side.

In the present arrangement example, a small-sized single-sided light emitting type organic EL panel (refer to FIG. 1) wherein a metal material having a reflectance of visible rays is arranged in the first layer (lowermost layer), and in the organic EL panel of the second layer which is formed as of a light taking out type (LCD panel side), a plurality of double-sided light emitting type organic EL panels (refer to FIG. 2) which pass light therethrough are laminated and are arranged alternately in upper and lower layers such that no-light emitting portions thereof may overlap with each other. Consequently, the no-light emitting portions of the first layer can be compensated for by light emission of the second layer to decrease the difference in light and shade thereby to improve the luminance of the entire organic EL backlight.

In order to arrange the organic EL panels 31a and 31b in a plane to configure the organic EL panel arrangements 51 and 52, the organic EL panels 31a and 31b are connected to each other by a bonding agent such as an ultraviolet curing type bonding agent or arranged so as to be fitted in a predetermined framework.

Further, also where the organic EL panel arrangements 51 and 52 are laminated upwardly and downwardly, they may be connected to each other by a bonding agent such as an ultraviolet curing type bonding agent similarly as described above, or the organic EL panel arrangements 51 and 52 may be fixed upwardly and downwardly by a framework for fixing the organic EL panel arrangements 51 and 52.

Furthermore, since the response time of the organic EL devices to driving is as short as approximately 10 microseconds, by adopting the structure wherein small-size organic EL panels are laminated upwardly and downwardly, scanning driving can be carried out wherein the organic EL devices are turned on in order like the upper layer first column 41 lower layer first column 42 upper layer second column 43 lower layer second column 44 . . . from the upper layer (or depending upon the layering method, lower layer) first column 41 toward the lower portion of the screen as seen in FIG. 4. This driving is controlled by driving means (driving circuit) not shown.

From this characteristic and structure, by arranging the small-sized organic EL panels of the first layer and the second layer alternately and successively driving the small-sized organic EL panels suitably, a scanning backlight of a high luminance can be implemented while unevenness in luminance is suppressed.

Further, according to this driving method, time axis driving conforming to the necessity can be carried out such as to turn on the upper layer first column and the lower layer first column simultaneously.

If a large-sized lighting apparatus is formed by arrangement of such small-sized organic EL panels, then there is no necessity to fabricate an organic EL panel as a single item, and only fabrication of small-sized organic EL panels is required. Therefore, by devising the manner of arrangement of the organic EL panels, unevenness arising from boundary lines of arrangement can be suppressed and also scanning driving can be implemented.

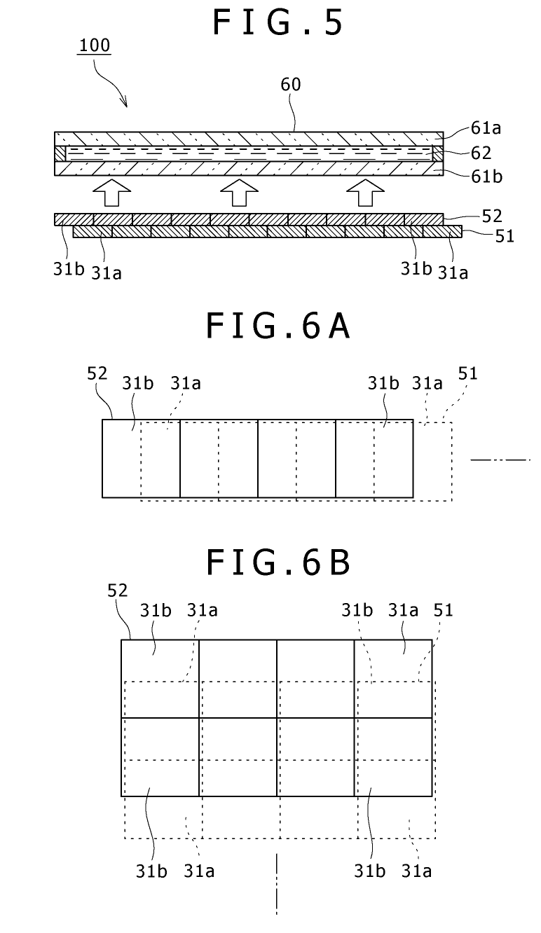

FIG. 5 is a schematic sectional view showing an example wherein the lighting apparatus of the present embodiment is applied to a liquid crystal display apparatus. A liquid crystal panel 60 includes a pair of glass substrates 61a and 61b arranged in an opposing relationship at predetermined distances and liquid crystal 62 filled in a gap between the glass substrates 61a and 61b, and TFTs (Thin Film Transistors) for driving the liquid crystal corresponding to pixels are formed, for example, on the glass substrate 61b to carry out light modulation.

Since the liquid crystal panel 60 is not self-luminous, it is necessary to introduce light from external lighting means (backlight) into the liquid crystal panel 60 in order to carry out optical modulation. The lighting apparatus of the present embodiment is used as this backlight. In particular, an item formed by layering the first layer organic EL panel arrangement 51 and the second layer organic EL panel arrangement 52 is used. Since the organic EL panel arrangements 51 and 52 are disposed in a state wherein the positions of joints in the upper and lower organic EL panels are displaced from each other as described hereinabove, light of a high luminance and of high uniformity can be irradiated upon the liquid crystal panel 60. Therefore, an image of good quality which is high in luminance and uniformity can be obtained as a liquid crystal apparatus 100.

Now, another example of the lighting apparatus of the present embodiment is described. FIG. 6 is a schematic view showing an example of arrangement wherein arrangements of the organic EL panels in the upper and lower organic EL panel arrays are displaced from each other in one direction. It is to be noted that, in FIG. 6, in order to facilitate recognition of the direction of the displacement, the upper and lower organic EL panels are shown in a state somewhat displaced obliquely from each other. FIG. 6A shows an example wherein the arrangements of the organic EL panels are displaced in a horizontal direction. In particular, in the structure wherein the second layer organic EL panel arrangement 52 is laminated on the first layer organic EL panel arrangement 51, a plurality of organic EL panels 31a which form the first layer organic EL panel arrangement 51 on the lower side and a plurality of organic EL panels 31b which form the second layer organic EL panel arrangement 52 on the upper side are arranged in a displaced relationship, for example, by one half pitch from each other in the horizontal direction. This example is suitable for configuration of a line type lighting apparatus.

Meanwhile, FIG. 6B shows another example wherein the arrangements of the organic EL panels are displaced in a vertical direction. In particular, in the structure wherein the organic EL panel arrangement 52 is laminated on the organic EL panel arrangement 51, a plurality of organic EL panels 31a which form the first layer organic EL panel arrangement 51 on the lower side and a plurality of organic EL panels 31b which form the second layer organic EL panel arrangement 52 on the upper side are arranged in a displaced relationship, for example, by one half pitch from each other in the vertical direction.

If the arrangements of the organic EL panels 31a and 31b are arranged in a displaced relationship from each other in one direction on the upper and lower organic EL panel arrangements 51 and 52, then a state wherein joints of the upper and lower organic EL panels do not overlap with each other is established, and light emission at the joints can be interpolated upwardly and downwardly.

It is to be noted that, in any example, the displacement in arrangement of the organic EL panels 31a and 31b of the upper and lower organic EL panel arrangements 51 and 52 may be other than one half pitch.

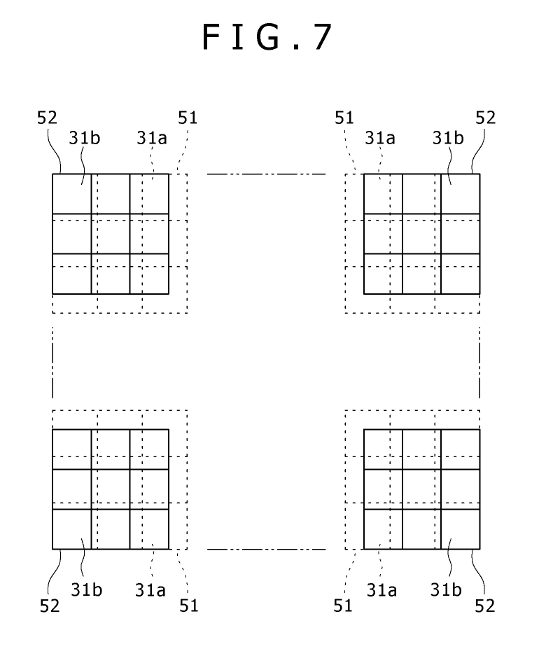

FIG. 7 is a schematic view showing an example wherein the sizes of the organic EL panels in the upper and lower organic EL panel arrangements are made different from each other. In particular, in the structure wherein the organic EL panel arrangement 52 is laminated on the organic EL panel arrangement 51, one of the upper and lower organic EL panels is made greater than the other organic EL panel. In the example shown in FIG. 7, the organic EL panels 31a of the organic EL panel arrangement 51 on the lower side are made greater than the organic EL panels 31b of the organic EL panel arrangement 52 on the upper side. Consequently, joints of the upper and lower organic EL panels are placed in a state wherein they do not overlap with each other, and light emission at the joints can be interpolated upwardly and downwardly.

Further, even if the organic EL panels 31a and 31b of the upper and lower organic EL panel arrangements 51 and 52 are different in size as in the example shown in FIG. 7, if the organic EL panels 31a and 31b are set such that the vertical and horizontal lengths thereof when they are juxtaposed coincide with the vertical and horizontal lengths of the entire lighting apparatus, then the upper and lower positions at end portions can be registered with each other.

In short, if the least common multiples of the lengths of the vertical and horizontal sides of the organic EL panels 31a and 31b of the upper and lower organic EL panel arrangements 51 and 52 are set so as to be equal to the lengths of the vertical and horizontal sides of the entire lighting apparatus, then the joints of the organic EL panels in both of the vertical and horizontal directions do not overlap with each other over the overall area of the lighting apparatus and the vertical and horizontal sizes of the upper and lower organic EL panel arrangements 51 and 52 can be made coincide with the vertical and horizontal sizes of the overall lighting apparatus.

According to this example, light emission at the joints can be interpolated upwardly and downwardly, and if organic EL panels having two different sizes are prepared, then a large-sized organic EL lighting apparatus of a high luminance and high uniformity can be implemented.

It is to be noted that, while, in the example shown in FIG. 7, the organic EL panels 31a on the lower side are made greater than the organic EL panels 31b on the upper side, conversely the organic EL panels 31a on the lower side may be smaller than the organic EL panels 31b on the upper side similarly. Further, as an application of the example wherein the organic EL panels 31a and 31b of the upper and lower organic EL panel arrangements 51 and 52 are different in size from each other, the upper and lower organic EL panels 31a and 31b may be made different from each other in the panel outer profile. For example, it is a possible idea to set, where the upper side organic EL panels 31b have a quadrangular shape, the shape of the lower side organic EL panels 31a to a triangular shape, a hexagonal shape or the like.

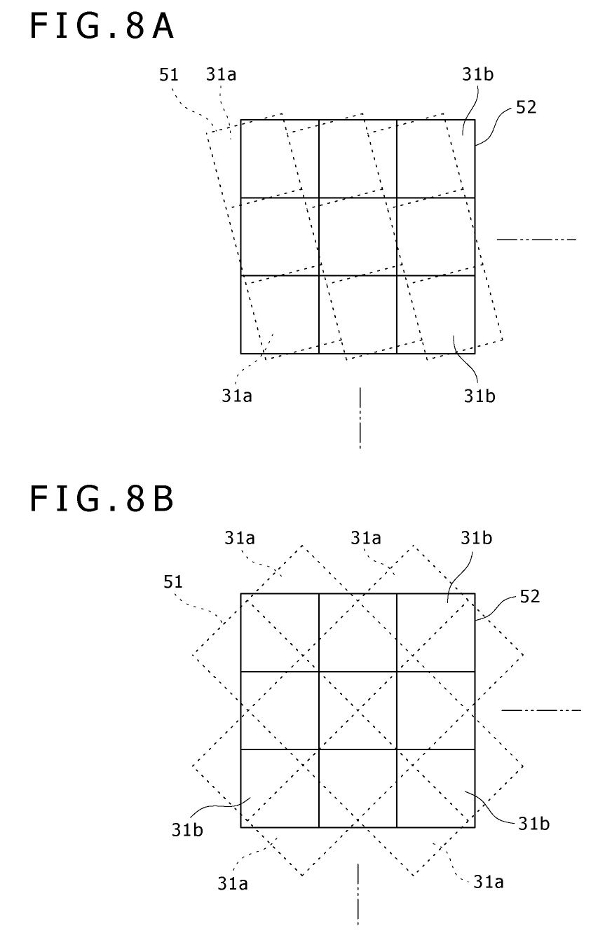

FIG. 8 is a schematic view showing examples wherein the organic EL panels of the upper and lower organic EL panel arrangements are made different in angle, and FIG. 8A shows an example wherein the lower side organic EL panels are rotated by approximately 15 degrees in the counterclockwise direction, and FIG. 8B shows another example wherein the lower side organic EL panels are rotated by approximately 45 degrees.

In both examples, if the arrangement angles of the organic EL panels 31a and 31b of the upper and lower organic EL panel arrangements 51 and 52 are made different from each other, then a state wherein the positions (directions) of joints of the organic EL panels 31a and 31b do not coincide with each other upwardly and downwardly, and light emission at the joints can be interpolated upwardly and downwardly.

Particularly, in the examples shown in FIG. 8, the organic EL panels 31a and 31b all of which have the same size can be used, and facilitation in fabrication and reduction in cost can be anticipated.

While, in the embodiment described above, organic EL panel arrangements are superposed principally upwardly and downwardly in two layers, three or more organic EL panel arrangements are superposed in different layers. Where organic EL panel arrangements are superposed in three or more layers, the single-sided light emitting type organic EL panel 10 (refer to FIG. 1) is used for the lowermost layer while the double-sided light emitting type organic EL panel 20 (refer to FIG. 2) is applied to and superposed in the other layers. Further, where organic EL panel arrangements are superposed in a plurality of layers, also it is possible to apply a configuration that the double-sided light emitting type organic EL panel 20 is applied to all layers while some reflection means is disposed at the lowermost portion.

Further, in regard to arrangement examples of upper and lower organic EL panels (an example wherein the arrangements are different in size, an arrangement wherein the arrangements are different in arrangement angle), the examples may each be used by itself or may be used in a suitable combination.

By disposing the single-sided light emitting type organic EL panel 10 and the double-sided light emitting type organic EL panels 20 or disposing only the double-sided light emitting type organic EL panels 20 in a laminated relationship in this manner, a backlight which uses an organic EL apparatus which is high in luminance and slim can be implemented.

Further, by using a structure wherein organic EL panels are arranged, the organic EL panels of a single item to be arranged can be miniaturized, and the following merits can be achieved.

(1) A vapor deposition apparatus used in an organic EL panel fabrication process can be miniaturized.

(2) The influence of a voltage drop of the organic EL apparatus is reduced.

(3) Since the film formation area of the organic EL apparatus decreases, film break by stress is less likely to occur.

(4) From the merits described above, a backlight can be provided less expensively while a voltage characteristic is maintained.

(5) Since small-sized panels are arranged, a scanning backlight can be implemented using organic EL which exhibits a high response speed.

Further, while, in the embodiment described above, an example wherein the lighting apparatus of the present embodiment is applied as lighting means (backlight) of a liquid crystal display apparatus is described, the lighting apparatus of the present embodiment can be applied also to other means. In particular, the lighting apparatus of the present embodiment can be applied also, for example, to medical appliances (a backlight for referring to an X-ray photograph and so forth) since a high luminance, high uniformity, reduction in thickness and increase in size can be implemented.

What is claimed is:

1. A lighting apparatus, characterized in that a light emitting panel layer formed from a plurality of light emitting panels disposed in a plane; and
a light emitting panel lamination section formed from a plurality of such light emitting panel layers laminated on each other;
a reflecting layer which reflects light being provided on that of said light emitting panel layers which is disposed most downwardly of said light emitting panel lamination section.

2. The lighting apparatus according to claim 1, characterized in that said light emitting panel layer includes an organic EL (Electro Luminescence) light emitting layer.

3. The lighting apparatus according to claim 1, characterized in that said reflecting layer is provided at a lowermost portion of that one of the plurality of light emitting panel layers of said light emitting panel lamination section which is arranged most downwardly.

4. The lighting apparatus according to claim 1, characterized in that
said light emitting panel lamination section includes a first light emitting panel layer and a second light emitting panel layer, and
the size of the light emitting panels of said first light emitting panel layer and the size of the light emitting panels of said second light emitting panel layer are different from each other.

5. The lighting apparatus according to claim 1, characterized in that
said light emitting panel lamination section includes a first light emitting panel layer and a second light emitting panel layer, and
where a boundary line between a first light emitting panel layer and a second light emitting panel layer of said first light emitting panel layer is represented by A and a boundary line between a third light emitting panel layer and a fourth light emitting panel layer of said second light emitting panel layer is represented by B,
the A and the B are displaced from each other on the same plane.

6. A liquid crystal display apparatus, characterized in that said liquid crystal display apparatus comprises:
a liquid crystal panel configured to modulate light based on an image signal; and
lighting means for irradiating the light upon said liquid crystal panel;
said lighting means including
a light emitting panel layer formed from a plurality of light emitting panels disposed in a plane, and
a light emitting panel lamination section formed from a plurality of such light emitting panel layers laminated on each otherm,
a reflecting layer which reflects light being provided on that of said light emitting panel layers which is disposed most downwardly of said light emitting panel lamination section.

7. The liquid crystal display apparatus according to claim 6, characterized in that said light emitting panel layer includes an organic EL (Electro Luminescence) light emitting layer.

8. The liquid crystal display apparatus according to claim 6, characterized in that said reflecting layer is provided at a lowermost portion of that one of the plurality of light emitting panel layers of said light emitting panel lamination section which is arranged most downwardly.

9. The liquid crystal display apparatus according to claim 6, characterized in that
said light emitting panel lamination section includes a first light emitting panel layer and a second light emitting panel layer, and
the size of the light emitting panels of said first light emitting panel layer and the size of the light emitting panels of said second light emitting panel layer are different from each other.

10. The liquid crystal display apparatus according to claim 6, characterized in that
said light emitting panel lamination section includes a first light emitting panel layer and a second light emitting panel layer, and
where a boundary line between a first light emitting panel layer and a second light emitting panel layer of said first light emitting panel layer is represented by A and a boundary line between a third light emitting panel layer and a fourth light emitting panel layer of said second light emitting panel layer is represented by B,
the A and the B are displaced from each other on the same plane.
